(19) United States
(12) Patent Application Publication
(10) Pub. No.: US 2026/0057538 A1
(43) Pub. Date: Feb. 26, 2026

(54) Devices and Methods for Dimensioning an Object

(71) Applicant: ZEBRA TECHNOLOGIES CORPORATION, Lincolnshire, IL (US)

(72) Inventors: Sanjeewa Thimirachandra, Kotugoda (LK); Raghavendra Tenkasi Shankar, Holbrook, NY (US); Sumudu B. Abeysekara, Marassana (LK)

(21) Appl. No.: 18/810,934

(22) Filed: Aug. 21, 2024

(51) Int. Cl. G06T 7/60; G06T 5/20; G06T 5/70; G06T 7/10; G06T 7/521; G06T 17/00

(52) U.S. Cl. CPC G06T 7/60; G06T 5/20; G06T 5/70; G06T 7/10; G06T 7/521; G06T 17/00; G06T 2200/04; G06T 2207/10028; G06T 2207/20081

(57) ABSTRACT

Devices and methods for dimensioning an object are disclosed herein. The method receives, from at least one sensor, at least one image of an object. The at least one image is indicative of a first perspective of the object and includes three-dimensional (3D) image data of the object. The method detects whether the object is cylindrical. Responsive to detecting the object is cylindrical, the method compensates for optical occlusion present in the 3D image data by filtering the 3D image data; segmenting the filtered 3D image data into horizontal sections; determining a radius of an arc of each horizontal section; generating a 3D model of the object based on the determined radii; and dimensioning the object based on the generated 3D model.

### BACKGROUND

A wide variety of applications require dimensioning of an object (e.g., a parcel, a package, freight, etc.). For example, the transportation (e.g., shipping and/or distribution) and storage of an object may require specifying the dimensions of the object to comply with regulatory requirements, to determine a shipping and/or storage cost for the object, or the like.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram illustrating an embodiment of the present disclosure.

FIG. 2 is a diagram illustrating components of the computing device of FIG. 1.

FIG. 3 is a flowchart illustrating processing steps carried out by an embodiment of the present disclosure.

FIGS. 4A-C are diagrams illustrating example objects.

FIG. 5 is a diagram illustrating step 306 of FIG. 3.

FIG. 6 is a flowchart illustrating step 308 of FIG. 3 in greater detail.

FIG. 7 is a diagram illustrating step 452 of FIG. 6.

FIG. 8 is a diagram illustrating step 454 of FIG. 6.

FIG. 9 is a diagram illustrating step 456 of FIG. 6.

FIG. 10 is a diagram illustrating processing steps carried out by an embodiment of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

As mentioned above, a wide variety of applications require dimensioning of an object (e.g., a parcel, a package, freight, etc.). For example, the transportation (e.g., shipping and/or distribution) and storage of an object may require specifying the dimensions of the object to comply with regulatory requirements, to determine a shipping and/or storage cost for the object, or the like. The dimensions of an object may not be known and therefore specifying the dimensions of the object may require manual intervention. For example, a user (e.g., a worker) may manually measure the object with a ruler or measuring tape which can be time consuming, cost-prohibitive (e.g., increased worker labor costs), and subject to human error (e.g., incorrectly reading or rounding a measurement and/or utilizing incorrect measurement units).

Conventional techniques utilizing image data to dimension an object may require specifying a position and an orientation of the image sensor relative to the object. However, position and orientation data may not be available when a mobile device is utilized to dimension an object and/or when an object is in motion.

Additionally, conventional techniques utilizing image data to dimension an object may not be suitable to dimension specific types of objects due to one or more attributes (e.g., size, shape, material, color, or the like) of the object. For example, image data of a cylindrical object (e.g., a barrel, a water tank, single or stacked tires, etc.) having uniform or variable radii cross sections suffers from occlusion which yields an optical illusion of the cylindrical object appearing smaller than its actual size. This phenomenon is observable via the human eye, image data captured by a camera sensor, and depth data generated by a three-dimensional (3D) sensor (e.g., a time-of-flight (TOF) sensor). For example, utilizing two-dimensional (2D) camera frames and 3D depth data to generate a bounding box to enclose a cylindrical object yields a bounding box smaller than the ground truth (e.g., the true size of the cylindrical object) due to occlusion present in the 2D camera data and 3D depth data. Additionally, the human eye cannot perceive the difference between the bounding box and the true size of the cylindrical object thereby yielding errors in dimensioning of the cylindrical object. In another example, utilizing 3D TOF depth data to generate a point cloud of a cylindrical object can yield an inaccurate and/or noisy point cloud due to expanding incident angles towards the opposing side walls of the cylindrical object. The expanding incident angles towards the opposing side walls of the cylindrical object reflect less light back to the TOF sensor such that the point cloud comprises increased noise towards the opposing side walls of the cylindrical object.

As such, conventional techniques (e.g., single shot and double shot dimensioning techniques) utilizing image data to dimension a cylindrical object fail to accurately dimension the true size of a cylindrical object. This failure can impede complying with regulatory requirements and/or certifications set forth by organizations (e.g., the National Conference on Weights and Measures (NTEP), the International Organization of Legal Metrology (OIML), etc.) for dimensioning objects accurately.

Thus, conventional devices, methods, and systems suffer from a general lack of versatility because these systems cannot automatically and dynamically compensate for optical occlusion present in image data of a cylindrical object. Overall, this lack of versatility causes conventional devices, methods, and systems to provide underwhelming performance and reduce the efficiency and general timeliness of executing dimensioning tasks. Thus, it is an objective of the present disclosure to eliminate these and other problems with conventional devices, methods, and systems via devices, systems, and methods that can automatically and dynamically detect whether an object is cylindrical and responsive to detecting the object is cylindrical, compensate for optical occlusion present in 3D image data of the object by filtering the 3D image data; segmenting the filtered 3D image data into horizontal sections; determining a radius of an arc of each horizontal section; generating a 3D model of the object based on the determined radii; and dimensioning the object based on the generated 3D model.

In accordance with the above, and with the disclosure herein, the present disclosure includes improvements in computer functionality or in improvements to other technologies at least because the present disclosure describes that, e.g., imaging and/or image processing devices and systems, and their related various components, may be improved or enhanced with the disclosed dynamic device and system features and methods that compensate for optical occlusion present in 3D image data of a cylindrical object to provide more accurate and efficient dimensioning of a cylindrical object. That is, the present disclosure describes improvements in the functioning of an imaging and/or image processing device and/or system itself or “any other technology or technical field” (e.g., the field of image processing). For example, the disclosed dynamic device and system features and methods improve and enhance the accuracy and efficiency of dimensioning a cylindrical object by compensating for optical occlusion present in 3D image data of the cylindrical object to mitigate (if not eliminate) worker error and eliminate inaccuracies and inefficiencies typically experienced over time by devices and systems lacking such features and methods. This improves the state of the art at least because such previous devices and systems are inaccurate and inefficient as they lack the ability to automatically and dynamically compensate for optical occlusion present in 3D image data of a cylindrical object.

In addition, the present disclosure applies various features and functionality, as described herein, with, or by use of, a particular machine, e.g., a processor, a mobile device (e.g., a phone, a tablet, a mobile computer, a sensor, a wearable, or a camera) and/or other hardware components as described herein. Moreover, the present disclosure includes specific features other than what is well-understood, routine, conventional activity in the field, or adds unconventional steps that demonstrate, in various embodiments, particular useful applications, e.g., automatically and dynamically detecting whether an object is cylindrical and responsive to detecting the object is cylindrical, compensating for optical occlusion present in 3D image data of the object in connection with accurately and efficiently dimensioning the object based on a generated 3D model.

Accordingly, it would be highly beneficial to develop a device, system and method that can automatically and dynamically detect whether an object is cylindrical and responsive to detecting the object is cylindrical, compensate for optical occlusion present in 3D image data of the object by filtering the 3D image data; segmenting the filtered 3D image data into horizontal sections; determining a radius of an arc of each horizontal section; generating a 3D model of the object based on the determined radii; and dimensioning the object based on the generated 3D model. The devices, systems, and methods of the present disclosure address these and other needs.

In an embodiment, the present disclosure is directed to a method. The method comprises: receiving, at a processor, from at least one sensor, at least one image of an object, the at least one image being indicative of a first perspective of the object and including three-dimensional (3D) image data of the object; detecting whether the object is cylindrical; responsive to detecting the object is cylindrical, compensating, by the processor, for optical occlusion present in the 3D image data by filtering the 3D image data; segmenting the filtered 3D image data into horizontal sections; determining a radius of an arc of each horizontal section; generating a 3D model of the object based on the determined radii; and dimensioning the object based on the generated 3D model.

In an embodiment, the present disclosure is directed to another method. The method comprises: receiving, at a processor, from at least one sensor, at least one image of a cylindrical object, the at least one image being indicative of a first perspective of the cylindrical object and including three-dimensional (3D) image data of the cylindrical object; compensating, by the processor, for optical occlusion present in the 3D image data by filtering the 3D image data; segmenting the filtered 3D image data into horizontal sections; determining a radius of an arc of each horizontal section; generating a 3D model of the object based on the determined radii; and dimensioning the object based on the generated 3D model.

In an embodiment, the present disclosure is directed to a device comprising at least one sensor; one or more processors; and a non-transitory computer-readable memory coupled to the one or more processors, the memory storing instructions thereon that, when executed by the one or more processors, cause the one or more processors to: receive, from the at least one sensor, at least one image of an object, the at least one image being indicative of a first perspective of the object and including three-dimensional (3D) image data of the object; detect whether the object is cylindrical; responsive to detecting the object is cylindrical, filter the 3D image data; segment the filtered 3D image data into horizontal sections; determine a radius of an arc of each horizontal section; generate a 3D model of the object based on the determined radii; and dimension the object based on the generated 3D model.

In an embodiment, the present disclosure is directed to a non-transitory computer-readable medium. The non-transitory computer-readable medium stores instructions thereon that, when executed by one or more processors, cause the one or more processors to: receive, from the at least one sensor, at least one image of an object, the at least one image being indicative of a first perspective of the object and including three-dimensional (3D) image data of the object; detect whether the object is cylindrical; responsive to detecting the object is cylindrical, filter the 3D image data; segment the filtered 3D image data into horizontal sections; determine a radius of an arc of each horizontal section; generate a 3D model of the object based on the determined radii; and dimension the object based on the generated 3D model.

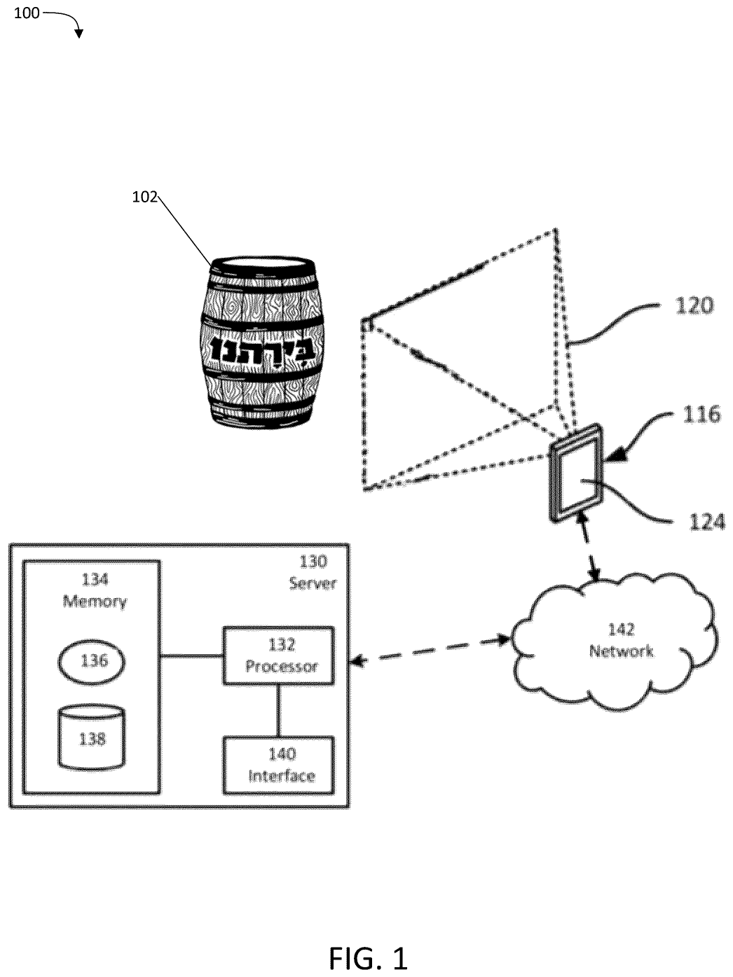

Turning to the Drawings, FIG. 1 is a diagram 100 illustrating an embodiment of the present disclosure. FIG. 1 illustrates a system for dimensioning an object. The system can be deployed in a facility (e.g., a grocery store, convenience store, big box store, a warehouse for fulfillment, distribution and/or storage, etc.).

As mentioned above, conventional techniques utilizing image data to dimension an object may not be suitable to dimension specific types of objects due to one or more attributes (e.g., size, shape, material, color, or the like) of the object. For example, image data of a cylindrical object (e.g., a barrel, a water tank, single or stacked tires, etc.) having uniform or variable radii cross sections suffers from occlusion which yields an optical illusion of the cylindrical object appearing smaller than its actual size. In another example, utilizing 3D time-of-flight depth data to generate a point cloud of a cylindrical object can yield an inaccurate and/or noisy point cloud due to expanding incident angles towards the opposing side walls of the cylindrical object. The expanding incident angles towards the opposing side walls of the cylindrical object reflect less light back to the TOF sensor such that the point cloud comprises increased noise towards the opposing side walls of the cylindrical object. The system provides for automatically and dynamically detecting whether an object is cylindrical and responsive to detecting the object is cylindrical, compensating for optical occlusion present in 3D image data of the object in connection with accurately and efficiently dimensioning the object based on a generated 3D model.

As shown in FIG. 1, the system can include a device 116, such as a smart phone, a tablet computer, a mobile computer, a wearable or the like. The device 116 can be operated by an operator (e.g., an associate) at the facility, and includes an imaging assembly (e.g., a camera) and/or a sensor (e.g., a TOF sensor) having a field of view (FOV) 120 and a display 124. The device 116 may receive an image of an object 102 where the image is indicative of a first perspective of the object 102 and including three-dimensional (3D) image data of the object.

Alternatively, the device 116 can be an imaging assembly (e.g., a camera) and/or a sensor (e.g., a TOF sensor). For example, the device 116 can be a camera and/or a TOF sensor mounted in a position such that the camera and/or TOF sensor has a FOV 120 including the object 102 and can be manipulated to capture an image or a stream of images of the object 102. From such images, the device 116 can automatically and dynamically detect whether an object 102 is cylindrical and responsive to detecting the object 102 is cylindrical, compensate for optical occlusion present in 3D image data of the object 102 in connection with accurately and efficiently dimensioning the object 102 based on a generated 3D model.

Certain components of a server 130 are also illustrated in FIG. 1. The server 130 can include a processor 132 (e.g. one or more central processing units (CPUs)), interconnected with a non-transitory computer readable storage medium, such as a memory 134 and an interface 140. The memory 134 includes a combination of volatile memory (e.g. Random Access Memory or RAM) and non-volatile memory (e.g. read only memory or ROM, Electrically Erasable Programmable Read Only Memory or EEPROM, flash memory). The processor 132 and the memory 134 each comprise one or more integrated circuits.

The memory 134 stores computer readable instructions for execution by the processor 132. The memory 134 stores a dimensioning application 136 (also referred to simply as the application 136) which, when executed by the processor 132, configures the processor 132 to perform various functions described below in greater detail and related to automatically and dynamically detecting whether an object is cylindrical and responsive to detecting the object is cylindrical, compensating for optical occlusion present in 3D image data of the object by filtering the 3D image data; segmenting the filtered 3D image data into horizontal sections; determining a radius of an arc of each horizontal section; generating a 3D model of the object based on the determined radii; and dimensioning the object based on the generated 3D model. As described below, this functionality can also be executed by the processor 202 of the device 116.

The application 136 may also be implemented as a suite of distinct applications in other examples. Those skilled in the art will appreciate that the functionality implemented by the processor 132 via the execution of the application 136 may also be implemented by one or more specially designed hardware and firmware components, such as field-programmable gate arrays (FPGAs), application-specific integrated circuits (ASICs) and the like in other embodiments. The memory 134 also stores a repository 138 including one or more image datasets of a plurality of objects (e.g., for training a machine learning model to detect whether an object is cylindrical). As noted below, the repository 138 may be stored in a memory (not shown) of the device 116.

The server 130 also includes a communications interface 140 enabling the server 130 to communicate with other computing devices, including the device 116, via the network 142. The communications interface 140 includes suitable hardware elements (e.g. transceivers, ports and the like) and corresponding firmware according to the communications technology employed by the network 142.

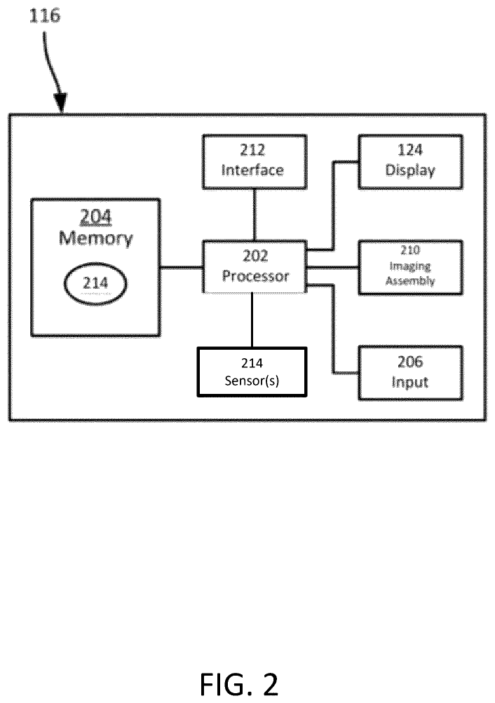

FIG. 2 is a diagram 200 illustrating components of the device 116 of FIG. 1. The device 116 includes a processor 202 (e.g. one or more CPUs), interconnected with a non-transitory computer readable storage medium, such as a memory 204, an input 206, a display 124, an imaging assembly 210, an interface 212, and sensor(s) 214. The memory 204 includes a combination of volatile memory (e.g. Random Access Memory or RAM) and non-volatile memory (e.g. read only memory or ROM, Electrically Erasable Programmable Read Only Memory or EEPROM, flash memory). The processor 202 and the memory 204 each comprise one or more integrated circuits.

The at least one input 206 can be a device interconnected with the processor 202. The input device 206 is configured to receive an input (e.g. from an operator of the device 116) and provide data representative of the received input to the processor 202. The input device 206 can include any one of, or a suitable combination of, a touch screen integrated with the display 124, a keypad, a microphone, and the like. For example, an operator can utilize the touchscreen or keypad to identify a shape of the object 102.

The imaging assembly 210 (e.g., a camera) may include a suitable sensor (e.g., a TOF sensor) or combination of sensors. Alternatively, the imaging assembly 210 and the sensor(s) 214 (e.g., a TOF sensor, a gyroscope, an accelerometer, etc.) may be independent of one another. In another alternative, the device 116 may be an imaging assembly 210 (e.g., a camera) and/or a sensor 214 (e.g., a TOF sensor). For example, the device 116 can be a camera and/or a TOF sensor mounted in a position such that the camera and/or TOF sensor has a FOV 120 including the object 102 and can be manipulated to capture an image or a stream of images of the object 102. From such images, the device 116 can automatically and dynamically detect whether an object 102 is cylindrical and responsive to detecting the object 102 is cylindrical, compensate for optical occlusion present in 3D image data of the object 102 in connection with accurately and efficiently dimensioning the object 102 based on a generated 3D model.

In addition to the display 124, the device 116 can also include one or more other output devices, such as a speaker, a notification light-emitting diode (LED), and the like (not shown). The communications interface 212 enables the device 116 to communicate with other computing devices, such as the server 130, via the network 142. The interface 212 therefore includes a suitable combination of hardware elements (e.g. transceivers, antenna elements and the like) and accompanying firmware to enable such communication.

The memory 204 stores computer readable instructions for execution by the processor 202. In particular, the memory 204 stores a dimensioning application 214 (also referred to simply as the application 214) which, when executed by the processor 202, configures the processor 202 to perform various functions discussed below in greater detail and related to automatically and dynamically detecting whether an object is cylindrical and responsive to detecting the object is cylindrical, compensating for optical occlusion present in 3D image data of the object by filtering the 3D image data; segmenting the filtered 3D image data into horizontal sections; determining a radius of an arc of each horizontal section; generating a 3D model of the object based on the determined radii; and dimensioning the object based on the generated 3D model.

The application 214 may also be implemented as a suite of distinct applications in other examples. Those skilled in the art will appreciate that the functionality implemented by the processor 202 via the execution of the application 214 may also be implemented by one or more specially designed hardware and firmware components, such as FPGAs, ASICs and the like in other embodiments. As noted above, in some examples the memory 204 can also store the repository 138, rather than the repository 138 being stored at the server 130. The repository 138 can include one or more image datasets of a plurality of objects (e.g., for training a machine learning model to detect whether an object is cylindrical).

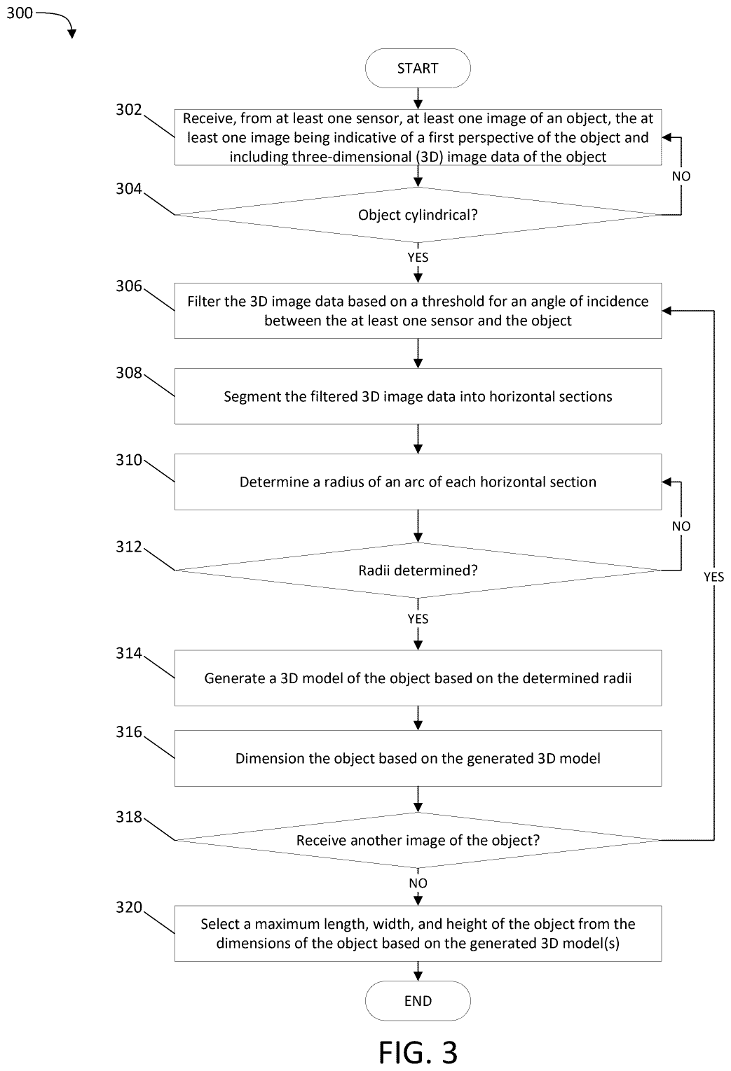

FIG. 3 is a flowchart 300 illustrating processing steps carried out by an embodiment of the present disclosure. The processing steps will be described in conjunction with their performance in the system (e.g., by the device 116 or the server 130 in conjunction with the device 116). In general, via performance of the processing steps, the system can automatically and dynamically detect whether an object is cylindrical and responsive to detecting the object is cylindrical, compensate for optical occlusion present in 3D image data of the object in connection with accurately and efficiently dimensioning the object based on a generated 3D model. For example, the system can receive, from at least one sensor, at least one image of an object where the at least one image is indicative of a first perspective of the object and includes 3D image data of the object, and, responsive to detecting the object is cylindrical, compensate for optical occlusion present in the 3D image data by filtering the 3D image data; segmenting the filtered 3D image data into horizontal sections; determining a radius of an arc of each horizontal section; generating a 3D model of the object based on the determined radii; and dimensioning the object based on the generated 3D model.

Referring to FIG. 3, in step 302, the system receives from at least one sensor 214, at least one image of an object 102. The at least one image can be indicative of a first perspective of the object 102 and can include 3D image data of the object 102. The at least one sensor 214 may be a TOF sensor and the 3D image data can include, but is not limited to a point cloud, color data associated with the point cloud, a color point cloud, and depth data. The system can capture the at least one image via the camera 210 (including the TOF sensor 214) or the TOF sensor 214 of the device 116 by manipulating the camera 210 or the TOF sensor 214 such that a FOV of the camera 210 or the TOF sensor 214 includes the object 102.

In step 304, the system detects whether an object 102 is cylindrical. The system may train a machine learning model based on historical data (e.g., datasets of a plurality of objects 102) to detect whether an object 102 is cylindrical and utilize the trained machine learning model when dimensioning an object 102 to detect whether an object 102 is cylindrical. Alternatively, the system may receive, via the input 206, an indication from an operator that an object 102 is cylindrical.

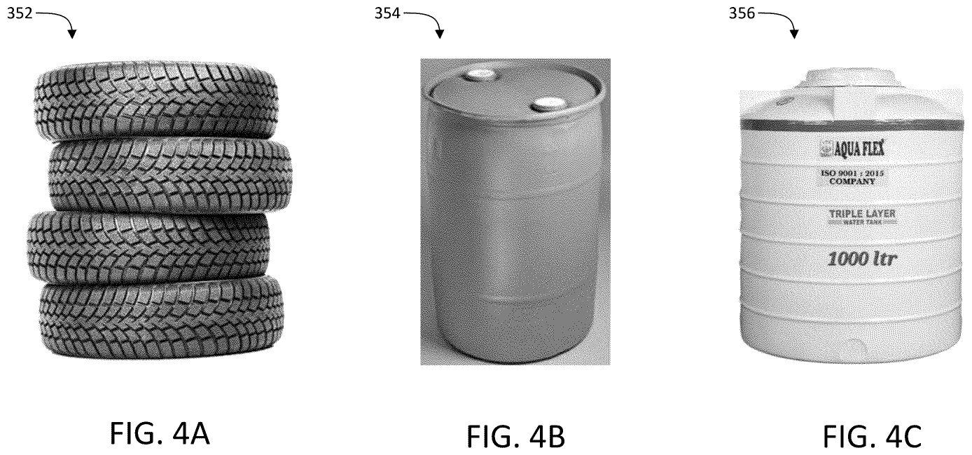

FIGS. 4A-4C are diagrams illustrating example objects 102. Referring to FIGS. 4A-4C an object 102 may be cylindrical and have fixed or variable radii cross sections. FIG. 4A illustrates stacked tires 352 to form a cylindrical shape having variable radii cross sections, FIG. 4B illustrates a cylindrical drum 354 having substantially fixed radii cross sections, and FIG. 4C illustrates a cylindrical water tank 356 having variable radii cross sections.

Returning to FIG. 3, if the system detects that the object 102 is cylindrical, then the process proceeds to step 306 and the system performs processing steps to compensate for optical occlusion present in the 3D image data of the object 102. Alternatively, if the system detects that the object 102 is not cylindrical, then the process returns to step 302.

In step 306, the system filters the 3D image data of the object 102. For example, the system removes one or more data points of the 3D image data that exceed a threshold for an angle of incidence between the sensor 214 and the object 102.

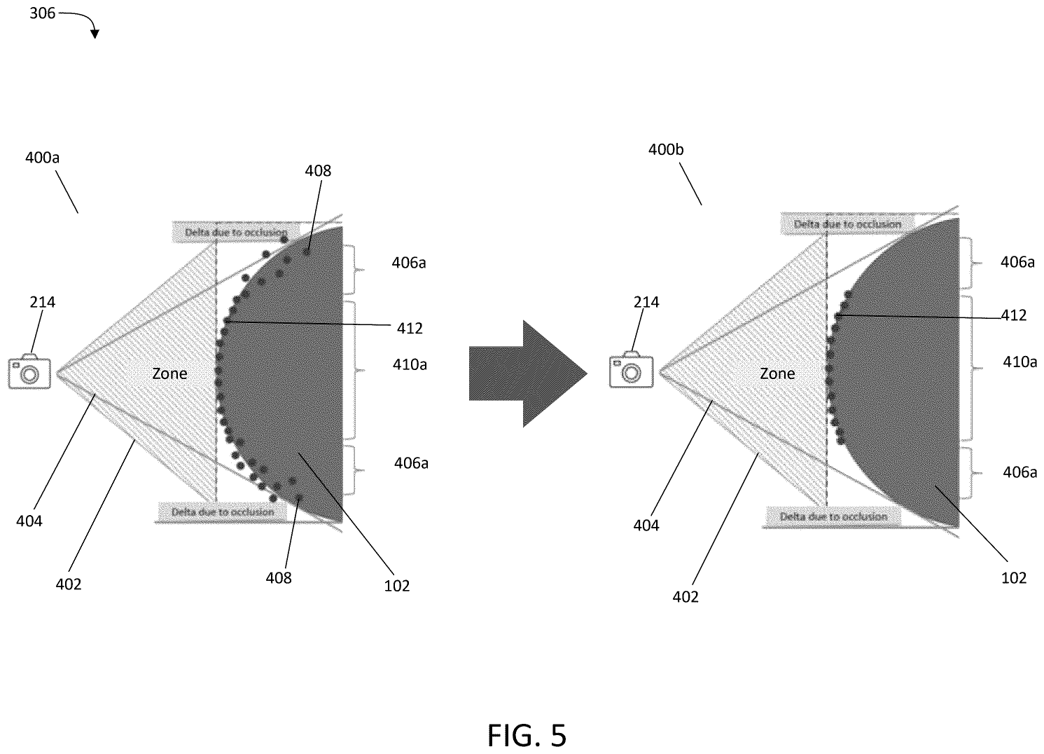

FIG. 5 is a diagram illustrating step 306 of FIG. 3. Referring to FIG. 5, the system filters the 3D image data of the object 102 based on an incident angle between the sensor 214 and the object 102. As shown in diagram 400a of FIG. 5, the sensor 214 has a FOV 402 including a zone 404 encompassing the object 102. Light from the sensor 214 may strike a surface of the object 102 at an incident angle within the zone 404 to yield point cloud depth points 408 and 412 along the surface of the object 102. As noted above, utilizing 3D image data of the sensor 214 to generate a point cloud of a cylindrical object 102 can yield an inaccurate and/or noisy point cloud due to expanding incident angles towards the opposing side walls of the cylindrical object 102. The expanding incident angles towards the opposing side walls of the cylindrical object 102 reflect less light back to the sensor 214. This yields a point cloud with increased noise (e.g., depth points 408 in the regions 406a) towards the opposing side walls of the cylindrical object 102 because the depth points 408 in the regions 406a do not accurately reflect a surface of the cylindrical object 102. In contrast, depth points 412 in the region 410a more accurately reflect a surface of the cylindrical object 102 due to narrower incident angles between the sensor 214 and the object 102. As such, the depth points 412 in the region 410a have a higher confidence level than the depth points 408 in the regions 406a. As shown in diagram 400b of FIG. 5, the system filters the 3D image data of the object 102 by removing the depth points 408 in the regions 406a such that the depth points 412 in the region 410a remain. The remaining depth points 412 in the region 410a are indicative of a surface of the object 102 that is less than the surface of the object 102 in the received at least one image of the object 102. It should be understood that the system can filter the 3D image data of the object 102 based on a threshold angle of incidence between the sensor 214 and the object 102 and/or a threshold for a confidence level of a depth point of the 3D image data. For example, the system can filter the 3D image data of the object 102 by removing one or more depth points of the 3D image data that exceed a threshold for an angle of incidence between the sensor 214 and the object 102. In another example, the system can filter the 3D image data of the object 102 by removing one or more depth points of the 3D image data that do not exceed a threshold for a confidence level of a depth point.

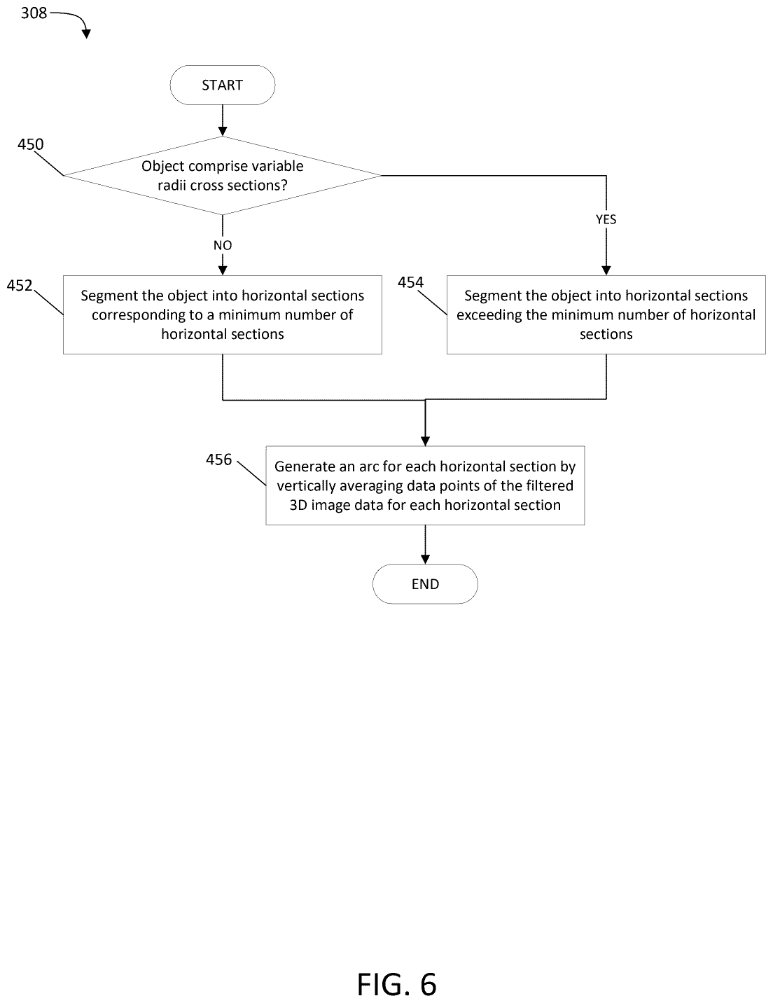

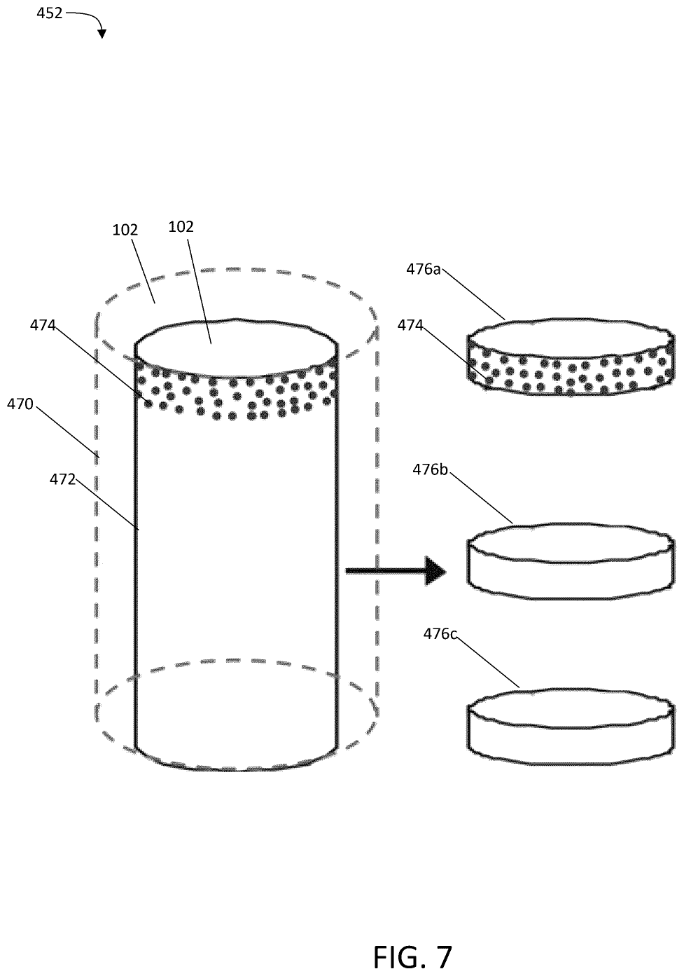

Referring back to FIG. 3, in step 308, the system segments the filtered 3D image data into horizontal sections. FIG. 6 is a flowchart illustrating step 308 of FIG. 3 in greater detail. As shown in FIG. 6, beginning in step 450, the system determines whether the object 102 comprises variable radii cross sections. If the system determines that the object 102 does not comprise variable radii cross sections (e.g., the object 102 has a uniform cylindrical shape), then the process proceeds to step 452. In step 452, the system segments the object 102 into horizontal sections (e.g., discs) corresponding to a minimum number of horizontal sections (e.g., three discs). FIG. 7 is a diagram illustrating step 452 of FIG. 6. Referring to FIG. 7, a dashed line 470 is indicative of a true size of an object 102 and a solid line 472 is indicative of a narrower size of the object 102. For example, the solid line 472 is indicative of filtered 3D image data (e.g., a filtered point cloud) including depth points 474 of the object 102. For simplicity, FIG. 7 illustrates a portion of the depth points 474 and it should be understood that an entirety of the surface area of the object 102 corresponding to the solid line 472 may include depth points. As shown in FIG. 7, the system determines that the object 102 does not comprise variable radii cross sections (e.g., the object 102 has a uniform cylindrical shape), and segments the object 102 into horizontal sections 476a-c (e.g., discs) corresponding to a minimum number of horizontal sections (e.g., three discs).

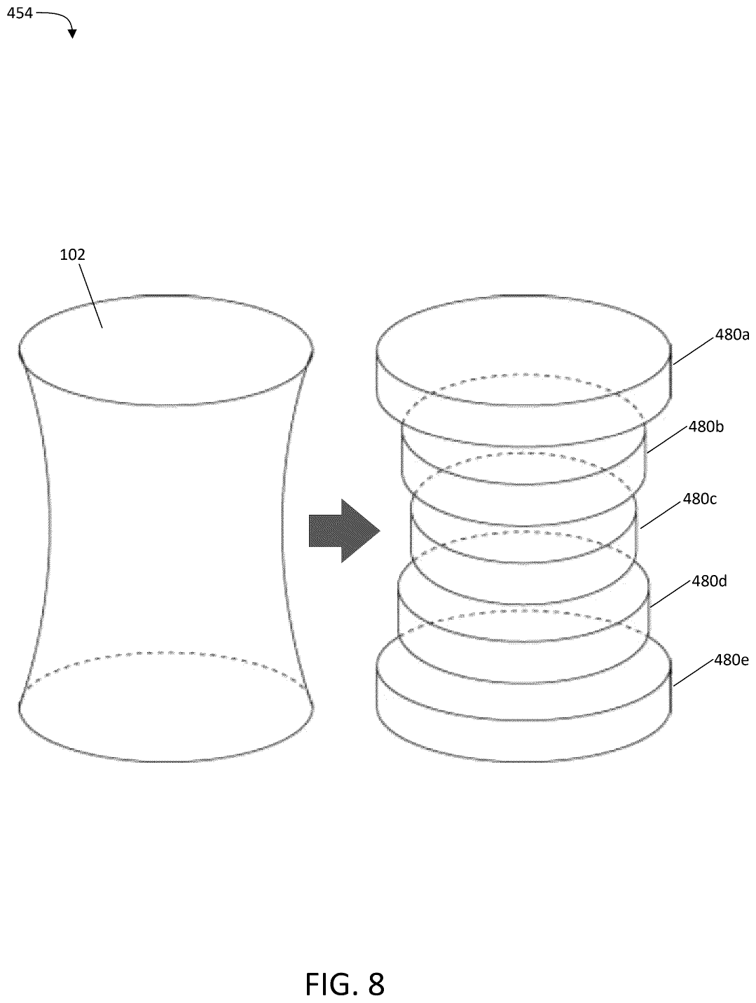

Referring back to FIG. 6, alternatively, if the system determines that the object 102 comprises variable radii cross sections (e.g., the object 102 does not have a uniform cylindrical shape), then the process proceeds to step 454. In step 454, the system segments the object 102 into horizontal sections (e.g., discs) that exceed the minimum number of horizontal sections (e.g., more than three discs). FIG. 8 is a diagram illustrating step 454 of FIG. 6. Referring to FIG. 8, the system determines that the object 102 comprises variable radii cross sections (e.g., the object 102 does not have a uniform cylindrical shape) and segments the object 102 into horizontal sections 480a-e (e.g., discs) that exceed the minimum number of horizontal sections (e.g., more than three discs).

In this way, the system can efficiently utilize processing resources to yield improved processing response time without adversely impacting accuracy based on whether the object 102 comprises variable radii sections. For example, segmenting an object 102 into an increasing number of horizontal sections generally provides for increased accuracy but may decrease processing response time. However, for a uniformly cylindrical object 102, an increasing number of horizontal sections does not provide for increased accuracy. As such, for a uniformly cylindrical object 102, the system can efficiently utilize processing resources to decrease processing response time without adversely impacting accuracy by segmenting the uniformly cylindrical object 102 into a minimum number of horizontal sections (e.g., a top horizontal section, a middle horizontal section, and a bottom horizontal section). The minimum number of horizontal sections can be a predetermined or variable threshold based on whether an object 102 comprises variable radii cross sections and/or a true size of the object 102.

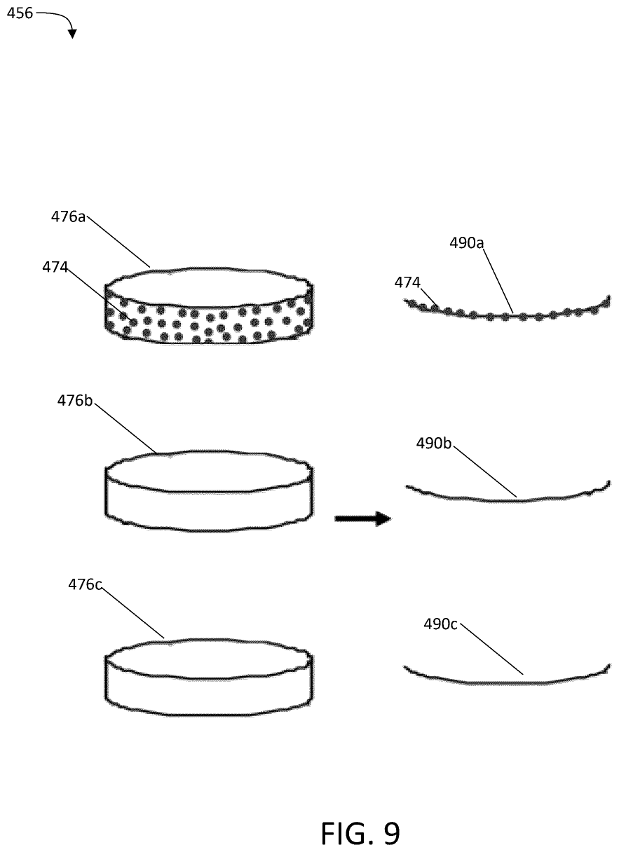

Referring back to FIG. 6, in step 456, the system generates an arc for each horizontal section of the object 102. For example, the system generates an arc for each horizontal section of the object 102 by vertically averaging data points (depth points) of the filtered 3D image data for each horizontal section. A width of each arc corresponds to a width of a data point (e.g., a depth point). FIG. 9 is a diagram illustrating step 456 of FIG. 6. Referring to FIG. 9, the system generates an arc 490a-c for each horizontal section 476a-c of the object 102 by vertically averaging depth points 474 of the filtered 3D image data for each horizontal section 476a-c. In this way, the system reduces a noise level of each arch 490a-c. As shown in FIG. 9, each arc 490a-c has a width corresponding to a width of a depth point 474.

Referring back to FIG. 3, in step 310, the system determines a radius of an arc of each horizontal section. As mentioned above, the system generates an arc for each horizontal section of the object 102 by vertically averaging data points (e.g., depth points) of the filtered 3D image data for each horizontal section. In this way, each arc has a width corresponding to a width of a depth point. The system determines a radius of an arc of each horizontal section via at least three distinct depth points of each arc. For example, the system may select a first data point of the filtered 3D image data positioned on a first end of the arc of each horizontal section, a second data point of the filtered 3D image data positioned on a second end of the arc of each horizontal section opposite the first end, and a third data point of the filtered 3D image data positioned midway between the first end and the second end of each horizontal section. In this way, the system can determine the radius of the arc of each horizontal section based on the selected first data point, the second data point, and the third data point. It should be understood that the system can select more than three distinct depth points of each arc to improve an accuracy of the determined radius.

In step 312, the system determines whether the radii have been determined. If the system determines that the radii have been determined, then the process proceeds to step 314. Alternatively, if the system determines that the radii have not been determined, then the process returns to step 310.

In step 314, the system generates a 3D model of the object 102 based on the determined radii. For example, the system can generate the 3D model of the object 102 based on the determined radii by deriving circles corresponding to the determined radii, assembling (e.g., stacking) the derived circles to generate the 3D model, and smoothing the generated 3D model. The smoothed 3D model provides for a size and surface of the object 102 that is substantially similar to the ground truth (e.g., the true size and surface of the object 102). In step 316, the system dimensions the object 102 based on the generated 3D model. For example, the system determines a length, width, and height of the object 102 based on the generated 3D model.

In step 318, the system determines whether another (e.g., a second) image of the object 102 is received. If the system determines that another image of the object 102 is not received, then the process proceeds to step 320. In step 320, the system selects a maximum length, width, and height of the object 102 from the determined dimensions of the object 102 based on the generated 3D model in step 316 and the process ends.

Alternatively, if the system determines that another (e.g., a second) image of the object 102 is received, then the process returns to step 306. Generally, the second image is indicative of a second perspective of the object 102 and includes second 3D image data of the object 102. The second 3D image data of the object 102 is processed as described above in relation to steps 306-316. If the system determines that another (e.g., a third) image of the object 102 is not received, then the process proceeds to step 320. In step 320, the system selects a maximum length, width, and height of the object 102 from the determined dimensions of the object 102 based on the generated 3D models corresponding to each image and perspective in step 316 and the process ends. In this way, the system can dimension the object 102 based on a plurality of images having different perspectives of the object 102 to improve an accuracy of dimensioning the object 102.

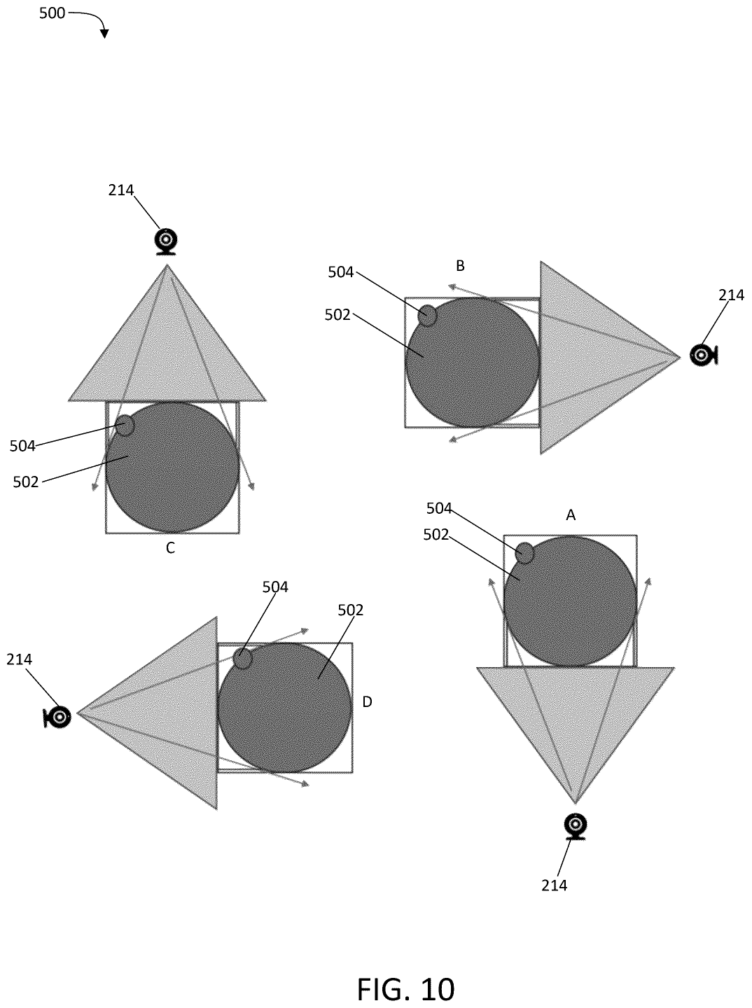

FIG. 10 is a diagram 500 illustrating processing steps carried out by an embodiment of the present disclosure. For example, FIG. 10 illustrates capturing, by a sensor 214, a plurality of images having different perspectives A-D of an object 502 having an irregularity 504. As shown in FIG. 10, perspectives A and B do not account for the irregularity 504 present in perspectives C and D. As such, by dimensioning an object based on a plurality of images having different perspectives of the object, the system can improve an accuracy of dimensioning the object. For example, the system can select a maximum length, width, and height of the object from the determined dimensions of the object based on generated 3D models corresponding to each image and perspective.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed:

1. A method, comprising:
receiving, at a processor, from at least one sensor, at least one image of an object, the at least one image being indicative of a first perspective of the object and including three-dimensional (3D) image data of the object;
detecting whether the object is cylindrical;
responsive to detecting the object is cylindrical, compensating, by the processor, for optical occlusion present in the 3D image data by
filtering the 3D image data;
segmenting the filtered 3D image data into horizontal sections;
determining a radius of an arc of each horizontal section;
generating a 3D model of the object based on the determined radii; and
dimensioning the object based on the generated 3D model.

2. The method of claim 1, wherein
the at least one sensor is a time-of-flight sensor, and
the 3D image data is one or more of a point cloud, color data associated with the point cloud, a color point cloud, and depth data.

3. The method of claim 1, wherein detecting whether the object is cylindrical comprises:
utilizing a machine learning model to detect whether the object is cylindrical; or
receiving an input indicative of the object being cylindrical.

4. The method of claim 1, wherein filtering the 3D image data comprises removing one or more data points of the 3D image data that exceed a threshold for an angle incidence between the at least one sensor and the object.

5. The method of claim 1, wherein segmenting the filtered 3D image data into horizontal sections comprises:
determining whether the object comprises variable radii cross sections;
responsive to determining the object does not comprise variable radii cross sections, segmenting the object into horizontal sections corresponding to a minimum number of horizontal sections;
responsive to determining the object comprises variable radii cross sections, segmenting the object into horizontal sections exceeding the minimum number of horizontal sections; and
generating the arc of each horizontal section by vertically averaging data points of the filtered 3D image data for each horizontal section, each arc having a width corresponding to a width of a data point.

6. The method of claim 1, wherein determining the radius of the arc of each horizontal section comprises:
selecting at least a first data point of the filtered 3D image data positioned on a first end of the arc of each horizontal section, a second data point of the filtered 3D image data positioned on a second end of the arc of each horizontal section opposite the first end, and a third data point of the filtered 3D image data positioned midway between the first end and the second end of each horizontal section; and
determining the radius of the arc of each horizontal section based on the selected first data point, the second data point, and the third data point.

7. The method of claim 1, wherein generating the 3D model of the object based on the determined radii comprises:
deriving circles corresponding to the determined radii;
assembling the derived circles to generate the 3D model; and
smoothing the generated 3D model.

8. The method of claim 1, further comprising:
receiving, at the processor, from the at least one sensor, another image of the object, the another image being indicative of a second perspective of the object and including second 3D image data of the object;
filtering the second 3D image data;
segmenting the filtered second 3D image data into horizontal sections;
determining a radius of an arc of each horizontal section;
generating a second 3D model of the object based on the determined radii;
dimensioning the object based on the generated second 3D model; and
selecting a maximum length, width, and height of the object from dimensions of the object based on the generated 3D model and the generated second 3D model.

9. A device, comprising:
at least one sensor;
one or more processors; and
a non-transitory computer-readable memory coupled to the one or more processors, the memory storing instructions thereon that, when executed by the one or more processors, cause the one or more processors to:
receive, from the at least one sensor, at least one image of an object, the at least one image being indicative of a first perspective of the object and including three-dimensional (3D) image data of the object;
detect whether the object is cylindrical;
responsive to detecting the object is cylindrical, filter the 3D image data;
segment the filtered 3D image data into horizontal sections;
determine a radius of an arc of each horizontal section;
generate a 3D model of the object based on the determined radii; and
dimension the object based on the generated 3D model.

10. The device of claim 9, wherein
the at least one sensor is a time-of-flight sensor, and
the 3D image data is one or more of a point cloud, color data associated with the point cloud, a color point cloud, and depth data.

11. The device of claim 9, wherein the instructions, when executed, cause the one or more processors to detect whether the object is cylindrical by:
utilizing a machine learning model to detect whether the object is cylindrical; or
receiving an input indicative of the object being cylindrical.

12. The device of claim 9, wherein the instructions, when executed, cause the one or more processors to filter the 3D image data by removing one or more data points of the 3D image data that exceed a threshold for an angle incidence between the at least one sensor and the object.

13. The device of claim 9, wherein the instructions, when executed, cause the one or more processors to segment the filtered 3D image data into horizontal sections by:
determining whether the object comprises variable radii cross sections;
responsive to determining the object does not comprise variable radii cross sections, segmenting the object into horizontal sections corresponding to a minimum number of horizontal sections;
responsive to determining the object comprises variable radii cross sections, segmenting the object into horizontal sections exceeding the minimum number of horizontal sections; and
generating the arc of each horizontal section by vertically averaging data points of the filtered 3D image data for each horizontal section, each arc having a width corresponding to a width of a data point.

14. The device of claim 9, wherein the instructions, when executed, cause the one or more processors to determine the radius of the arc of each horizontal section by:
selecting at least a first data point of the filtered 3D image data positioned on a first end of the arc of each horizontal section, a second data point of the filtered 3D image data positioned on a second end of the arc of each horizontal section opposite the first end, and a third data point of the filtered 3D image data positioned midway between the first end and the second end of each horizontal section; and
determining the radius of the arc of each horizontal section based on the selected first data point, the second data point, and the third data point.

15. The device of claim 9, wherein the instructions, when executed, cause the one or more processors to generate the 3D model of the object based on the determined radii by:
deriving circles corresponding to the determined radii;
assembling the derived circles to generate the 3D model; and
smoothing the generated 3D model.

16. The device of claim 9, wherein the instructions, when executed, further cause the one or more processors to:
receive, from the at least one sensor, another image of the object, the another image being indicative of a second perspective of the object and including second 3D image data of the object;
filter the second 3D image data;
segment the filtered second 3D image data into horizontal sections;
determine a radius of an arc of each horizontal section;
generate a second 3D model of the object based on the determined radii;
dimension the object based on the generated second 3D model; and
select a maximum length, width, and height of the object from dimensions of the object based on the generated 3D model and the generated second 3D model.

17. A non-transitory computer-readable medium storing instructions thereon that, when executed by one or more processors, cause the one or more processors to:
receive, from the at least one sensor, at least one image of an object, the at least one image being indicative of a first perspective of the object and including three-dimensional (3D) image data of the object;
detect whether the object is cylindrical;
responsive to detecting the object is cylindrical, filter the 3D image data;
segment the filtered 3D image data into horizontal sections;
determine a radius of an arc of each horizontal section;
generate a 3D model of the object based on the determined radii; and
dimension the object based on the generated 3D model.

18. The non-transitory computer-readable medium of claim 17, wherein the instructions, when executed, cause the one or more processors to filter the 3D image data by removing one or more data points of the 3D image data that exceed a threshold for an angle incidence between a field of view of the at least one sensor and the object.

19. The non-transitory computer-readable medium of claim 17, wherein the instructions, when executed, cause the one or more processors to segment the filtered 3D image data into horizontal sections by:
determining whether the object comprises variable radii cross sections;
responsive to determining the object does not comprise variable radii cross sections, segmenting the object into horizontal sections corresponding to a minimum number of horizontal sections;
responsive to determining the object comprises variable radii cross sections, segmenting the object into horizontal sections exceeding the minimum number of horizontal sections; and
generating the arc of each horizontal section by vertically averaging data points of the filtered 3D image data for each horizontal section, each arc having a width corresponding to a width of a data point.

20. The non-transitory computer-readable medium of claim 17, wherein the instructions, when executed, cause the one or more processors to determine the radius of the arc of each horizontal section by:
selecting at least a first data point of the filtered 3D image data positioned on a first end of the arc of each horizontal section, a second data point of the filtered 3D image data positioned on a second end of the arc of each horizontal section opposite the first end, and a third data point of the filtered 3D image data positioned midway between the first end and the second end of each horizontal section; and
determining the radius of the arc of each horizontal section based on the selected first data point, the second data point, and the third data point.

21. The non-transitory computer-readable medium of claim 17, wherein the instructions, when executed, cause the one or more processors to generate the 3D model of the object based on the determined radii by:
deriving circles corresponding to the determined radii;
assembling the derived circles to generate the 3D model; and
smoothing the generated 3D model.

22. The non-transitory computer-readable medium of claim 17, wherein the instructions, when executed, further cause the one or more processors to:
receive, from the at least one sensor, another image of the object, the another image being indicative of a second perspective of the object and including second 3D image data of the object;
filter the second 3D image data;
segment the filtered second 3D image data into horizontal sections;
determine a radius of an arc of each horizontal section;
generate a second 3D model of the object based on the determined radii;
dimension the object based on the generated second 3D model; and
select a maximum length, width, and height of the object from dimensions of the object based on the generated 3D model and the generated second 3D model.

23. A method, comprising:
receiving, at a processor, from at least one sensor, at least one image of a cylindrical object, the at least one image being indicative of a first perspective of the cylindrical object and including three-dimensional (3D) image data of the cylindrical object;
compensating, by the processor, for optical occlusion present in the 3D image data by
filtering the 3D image data;
segmenting the filtered 3D image data into horizontal sections;
determining a radius of an arc of each horizontal section;
generating a 3D model of the object based on the determined radii; and
dimensioning the object based on the generated 3D model.
